(19) United States
(12) Patent Application Publication
(10) Pub. No.: US 2017/0200334 A1
(43) Pub. Date: Jul. 13, 2017

(54) PERSONAL DEVICE LOCATION AUTHENTICATION FOR SECURED FUNCTION ACCESS

(71) Applicant: FORD GLOBAL TECHNOLOGIES, LLC, Dearborn, MI (US)

(72) Inventors: Pietro BUTTOLO, Dearborn Heights, MI (US); James Stewart RANKIN, II, Novi, MI (US); Stephen Ronald TOKISH, Sylvania, OH (US); Stuart C. SALTER, White Lake, MI (US)

(21) Appl. No.: 14/990,893

(22) Filed: Jan. 8, 2016

(51) Int. Cl. G07C 9/00; B60R 16/023; B60R 25/20

(52) U.S. Cl. CPC G07C 9/00103; B60R 25/2018; B60R 16/023; G07C 9/00015

(57) ABSTRACT

A personal device may perform a first triangulation using signal strength information of connections between the personal device and a plurality of in-vehicle components of a vehicle. A secured function request may be sent from the personal device to an access component of the vehicle when a location of the personal device is determined to be within the vehicle by the personal device. Signal strength information of the personal device may be forwarded to the access component from the plurality of in-vehicle components. The personal device may receive a response from the access component granting the secured function request when the forwarded signal strength information confirms the location of the second personal device as being within the vehicle.

### TECHNICAL FIELD

Aspects of the disclosure generally relate to authentication of personal device location for access to secured functions.

### BACKGROUND

When a driver or other user in possession of a passive entry device approaches a vehicle, a short-range signal from the passive entry device authenticates the user to unlock one or more vehicle doors. Some passive entry systems may also provide for automated locking of doors, as the keyless entry device leaves proximity of the vehicle.

### SUMMARY

In a first illustrative embodiment, a system includes a plurality of in-vehicle components; and an access component of a vehicle, programmed to receive a secured function request from a personal device, triangulate the personal device responsive to the request, to identify a location of the personal device using signal strength information of the personal device forwarded to the access component from the plurality of in-vehicle components, and grant the secured function request when the location is inside the vehicle.

In a second illustrative embodiment, a method includes receiving, by an access component, a secured function request from a personal device when a first triangulation performed by the personal device indicates the personal device is within a vehicle; and granting the secured function request when a second triangulation performed by the access component using signal strength information of the personal device forwarded to the access component from a plurality of in-vehicle components confirms the personal device is within the vehicle.

In a third illustrative embodiment, a system includes a personal device including a wireless transceiver and a processor programmed to send a secured function request to an access component of a vehicle when a location of the personal device is determined to be within the vehicle according to a first triangulation performed using signal strength information of connections between the wireless transceiver and a plurality of in-vehicle components of the vehicle; and receive a response granting the secured function request from the access component when signal strength information of the personal device forwarded to the access component from the plurality of in-vehicle components confirms the location of the personal device as being within the vehicle.

### BRIEF DESCRIPTION OF THE DRAWINGS

FIG. 1A illustrates an example system including a vehicle having a mesh of in-vehicle components configured to locate and interact with users and personal devices of the users;

FIG. 1B illustrates an example in-vehicle component equipped with a wireless transceiver configured to facilitate detection of and identify proximity of the personal devices;

FIG. 1C illustrates an example in-vehicle component requesting signal strength from other in-vehicle components of the vehicle;

FIG. 2A illustrates an example diagram of a user carrying a personal device lacking an access token attempting entry to the vehicle;

FIG. 2B illustrates an example diagram of the user having entered the vehicle receiving the access token granting the carrier of the personal device with access rights to the vehicle;

FIG. 3 illustrates an example diagram of the personal device entering the vehicle having the mesh of in-vehicle components;

FIG. 4 illustrates an example diagram of a personal device-centric approach to identifying the location of the personal device;

FIGS. 5A and 5B illustrate example diagrams of an access component-centric approach to identifying the location of the personal device;

FIGS. 6A, 6B and 6C illustrate example diagrams of a hybrid approach to identifying the location of a plurality of personal devices; and

FIG. 7 illustrates an example process for using the hybrid approach to identify locations of personal devices.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle interior modules, such as reading lights or speakers, may be enhanced with a wireless communication interface (such as Bluetooth Low Energy (BLE)). These enhanced modules of the vehicle interior may be referred to as in-vehicle components. Vehicle occupants may utilize their smartphones or other personal devices to wirelessly control features of the in-vehicle components using the communication interface. In an example, a vehicle occupant may utilize an application installed to the personal device to turn a reading light on or off, or to adjust a volume of a speaker. Some features, such as the reading lights or audio volume, may be considered to be low security features that do not require authentication of the personal device. Other features, such as unlocking a vehicle glove box or generating an access code that may be used for vehicle re-entry, may be considered secured functions. Access to secured functions may require that the personal device be confirmed to be within the vehicle cabin.

Signal strength of wireless connections between the personal device and a plurality of the in-vehicle components may be used to determine the location of the personal device. In a personal-device centric approach, the personal device may identify signal strength information between the personal device and the plurality of the in-vehicle components, and use the received signal strength information to determine whether the personal device is located inside or outside of the vehicle. Such an implementation may be simple to create, but may lack security as it relies on the personal device to honestly declare whether it is located inside or outside the vehicle.

A different solution may allow for the triangulation to be performed using components of the vehicle. In a component-centric approach, the personal device may advertise itself, thus enabling the in-vehicle components to determine an intensity of signal of the personal device as it is received (e.g., using received signal strength indication (RSSI) information from the connections between the personal device and the in-vehicle components). The in-vehicle components performing secured functions may listen for these advertisements from other in-vehicle components. The in-vehicle components may forward the media access control (MAC) or other address of the personal device and its respective signal strength information as advertisement packets that can be received by the in-vehicle components performing secured functions. These secured function components may use the forwarded signal-strength information to perform triangulation for the detected personal devices.

The component-centric implementation is more robust with respect to security, since it would be much more difficult to spoof signal strength from all in-vehicle components congruently and simultaneously as compared to announcing presence within the vehicle. However, such an implementation is also more resource intensive with respect to the vehicle and may not scale as well as the number of personal devices within the vehicle increases. This is because each personal device uses resources of the vehicle for triangulation regardless of whether the personal device is located inside or outside the vehicle, and regardless of whether the personal device is actually being used for interaction with the secured functions of the vehicle.

A hybrid validation scheme may be used to provide for security and greater scalability. Using the hybrid scheme, a first triangulation is performed by the personal device requesting a secured function using the device-centric approach. When the personal device determines that it is inside the interior of the vehicle, the personal device issues a request for validation to the in-vehicle component providing the secured function. The in-vehicle component providing the secured function listens and collects forwarded advertised signal strength information of the personal device from the in-vehicle components, similar as described in the component-centric approach, and perform a second triangulation. If the personal device is confirmed to be inside the vehicle, the request is granted to the personal device. Additionally, the location of the personal device may be updated in a component database indicating which personal devices are confirmed to be inside the vehicle. If the personal device is not confirmed as being within the vehicle, an alert may be raised or otherwise initiated by the system.

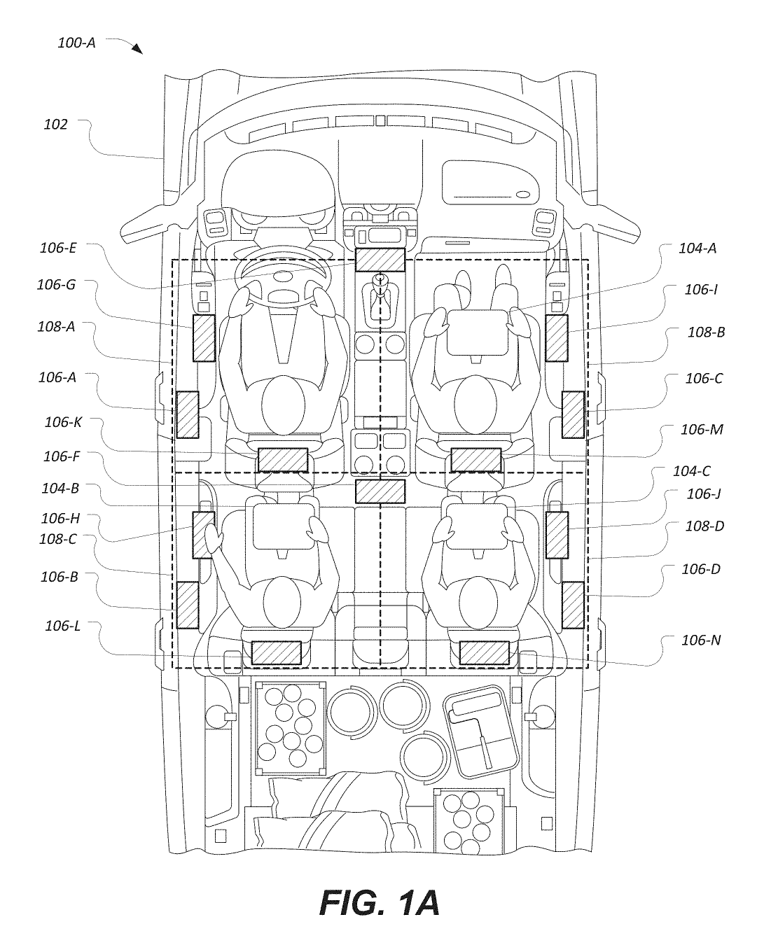

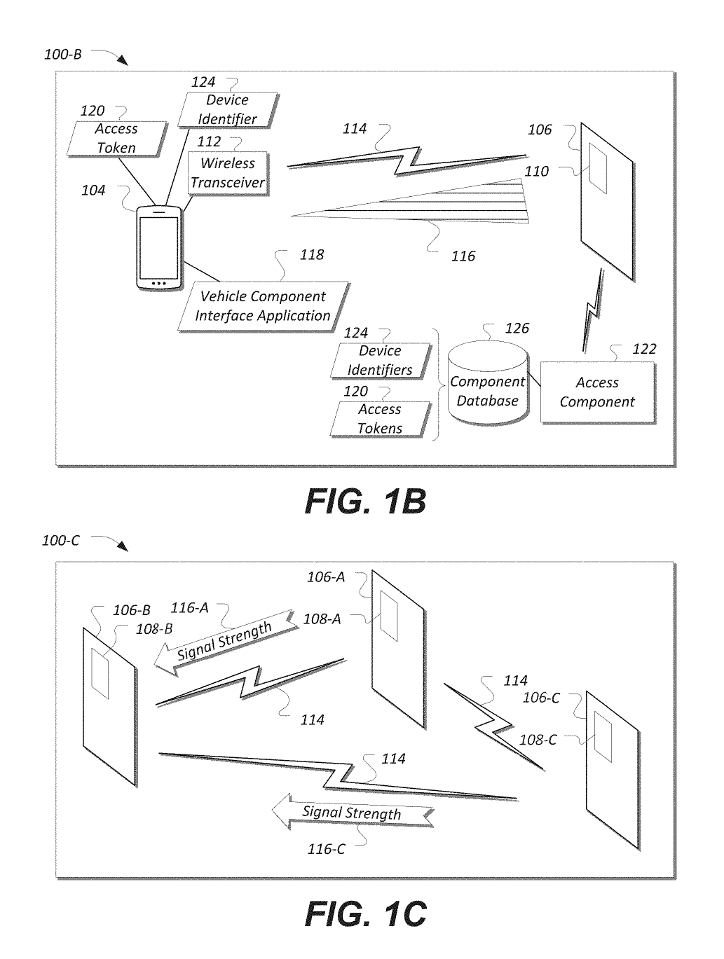

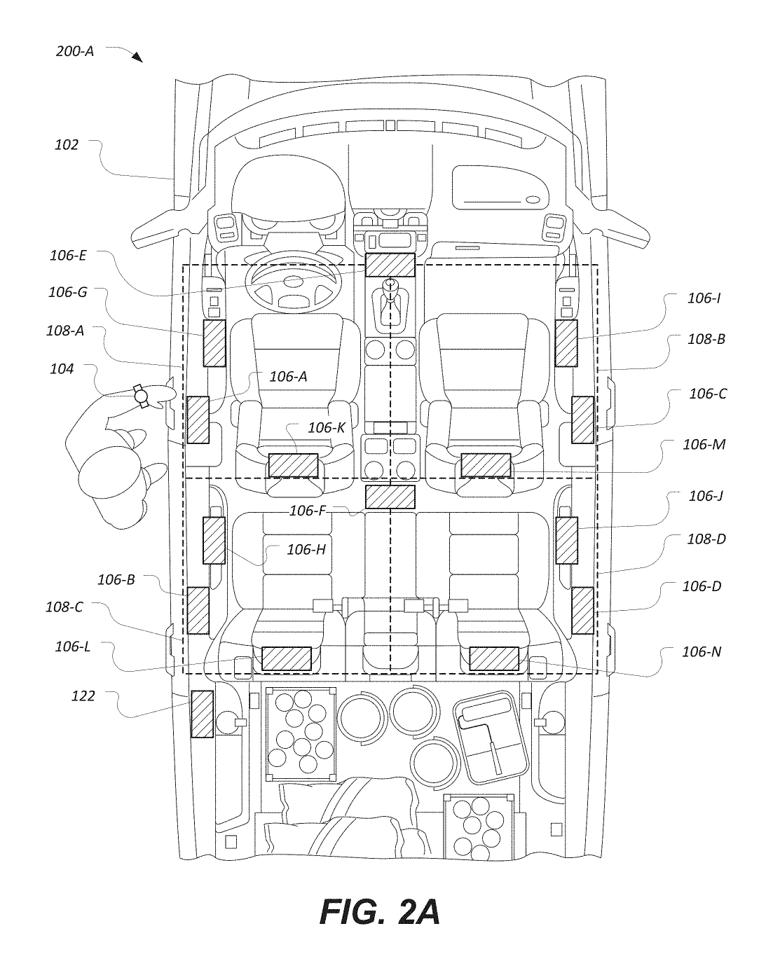

FIG. 1A illustrates an example system 100 including a vehicle 102 having a mesh of in-vehicle components 106 configured to locate and interact with users and personal devices 104 of the users. The system 100 may be configured to allow the users, such as vehicle occupants, to seamlessly interact with the in-vehicle components 106 in the vehicle 102 or with any other framework-enabled vehicle 102. Moreover, the interaction may be performed without requiring the personal devices 104 to have been paired with or be in communication with a head unit or other centralized computing platform of the vehicle 102.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the capabilities of the vehicle 102 may correspondingly vary. As some other possibilities, vehicles 102 may have different capabilities with respect to passenger capacity, towing ability and capacity, and storage volume.

The personal devices 104-A, 104-B and 104-C (collectively 104) may include mobile devices of the users, and/or wearable devices of the users. The mobile devices may be any of various types of portable computing device, such as cellular phones, tablet computers, smart watches, laptop computers, portable music players, or other devices capable of networked communication with other mobile devices. The wearable devices may include, as some non-limiting examples, smartwatches, smart glasses, fitness bands, control rings, or other personal mobility or accessory device designed to be worn and to communicate with the user's mobile device.

The in-vehicle components 106-A through 106-N (collectively 106) may include various elements of the vehicle 102 having user-configurable settings. These in-vehicle components 106 may include, as some examples, overhead light in-vehicle components 106-A through 106-D, climate control in-vehicle components 106-E and 106-F, seat control in-vehicle components 106-G through 106-J, and speaker in-vehicle components 106-K through 106-N. Other examples of in-vehicle components 106 are possible as well, such as rear seat entertainment screens or automated window shades. In many cases, the in-vehicle component 106 may expose controls such as buttons, sliders, and touchscreens that may be used by the user to configure the particular settings of the in-vehicle component 106. As some possibilities, the controls of the in-vehicle component 106 may allow the user to set a lighting level of a light control, set a temperature of a climate control, set a volume and source of audio for a speaker, and set a position of a seat.

The vehicle 102 interior may be divided into multiple zones 108, where each zone 108 may be associated with a seating position within the vehicle 102 interior. For instance, the front row of the illustrated vehicle 102 may include a first zone 108-A associated with the driver seating position, and a second zone 108-B associated with a front passenger seating position. The second row of the illustrated vehicle 102 may include a third zone 108-C associated with a driver-side rear seating position and a fourth zone 108-D associated with a passenger-side rear seating position. Variations on the number and arrangement of zones 108 are possible. For instance, an alternate second row may include an additional fifth zone 108 of a second-row middle seating position (not shown). Four occupants are illustrated as being inside the example vehicle 102, three of whom are using personal devices 104. A driver occupant in the zone 108-A is not using a personal device 104. A front passenger occupant in the zone 108-B is using the personal device 104-A. A rear driver-side passenger occupant in the zone 108-C is using the personal device 104-B. A rear passenger-side passenger occupant in the zone 108-D is using the personal device 104-C.

Each of the various in-vehicle components 106 present in the vehicle 102 interior may be associated with the one or more of the zones 108. As some examples, the in-vehicle components 106 may be associated with the zone 108 in which the respective in-vehicle component 106 is located and/or the one (or more) of the zones 108 that is controlled by the respective in-vehicle component 106. For instance, the light in-vehicle component 106-C accessible by the front passenger may be associated with the second zone 108-B, while the light in-vehicle component 106-D accessible by passenger-side rear may be associated with the fourth zone 108-D. It should be noted that the illustrated portion of the vehicle 102 in FIG. 1A is merely an example, and more, fewer, and/or differently located in-vehicle components 106 and zones 108 may be used.

Referring to FIG. 1B, each in-vehicle component 106 may be equipped with a wireless transceiver 110 configured to facilitate detection of and identify proximity of the personal devices 104. In an example, the wireless transceiver 110 may include a wireless device, such as a Bluetooth Low Energy transceiver configured to enable low energy Bluetooth signal intensity as a locator, to determine the proximity of the personal devices 104. Detection of proximity of the personal device 104 by the wireless transceiver 110 may, in an example, cause a vehicle component interface application 118 of the detected personal device 104 to be activated.

In many examples the personal devices 104 may include a wireless transceiver 112 (e.g., a BLUETOOTH module, a ZIGBEE transceiver, a Wi-Fi transceiver, an IrDA transceiver, an RFID transceiver, etc.) configured to communicate with other compatible devices. In an example, the wireless transceiver 112 of the personal device 104 may communicate data with the wireless transceiver 110 of the in-vehicle component 106 over a wireless connection 114. In another example, a wireless transceiver 112 of a wearable personal device 104 may communicate data with a wireless transceiver 112 of a mobile personal device 104 over a wireless connection 114. The wireless connections 114 may be a Bluetooth Low Energy (BLE) connection, but other types of local wireless connection 114, such as Wi-Fi or Zigbee may be utilized as well.

The personal devices 104 may also include a device modem configured to facilitate communication of the personal devices 104 with other devices over a communications network. The communications network may provide communications services, such as packet-switched network services (e.g., Internet access, VoIP communication services), to devices connected to the communications network. An example of a communications network may include a cellular telephone network. To facilitate the communications over the communications network, personal devices 104 may be associated with unique device identifiers 124 (e.g., media access control (MAC) addresses, mobile device numbers (MDNs), Internet protocol (IP) addresses, identifiers of the device modems, etc.) to identify the communications of the personal devices 104 over the communications network. These personal device identifiers 124 may also be utilized by the in-vehicle component 106 to identify the personal devices 104.

The vehicle component interface application 118 may be an application installed to a memory or other storage of the personal device 104. The vehicle component interface application 118 may be configured to facilitate vehicle occupant access to features of the in-vehicle components 106 exposed for networked configuration via the wireless transceiver 110. In some cases, the vehicle component interface application 118 may be configured to identify the available in-vehicle components 106, identify the available features and current settings of the identified in-vehicle components 106, and determine which of the available in-vehicle components 106 are within proximity to the vehicle occupant (e.g., in the same zone 108 as the location of the personal device 104). The vehicle component interface application 118 may be further configured to display a user interface descriptive of the available features, receive user input, and provide commands based on the user input to allow the user to control the features of the in-vehicle components 106. Thus, the system 100 may be configured to allow vehicle occupants to seamlessly interact with the in-vehicle components 106 in the vehicle 102, without requiring the personal devices 104 to have been paired with or be in communication with a head unit of the vehicle 102.

The system 100 may use one or more device location-tracking techniques to identify the zone 108 in which the personal device 104 is located. Location-tracking techniques may be classified depending on whether the estimate is based on proximity, angulation or lateration. Proximity methods are “coarse-grained,” and may provide information regarding whether a target is within a predefined range but they do not provide an exact location of the target. Angulation methods estimate a position of the target according to angles between the target and reference locations. Lateration provide an estimate of the target location, starting from available distances between target and references. The distance of the target from a reference can be obtained from a measurement of signal strength 116 over the wireless connection 114 between the wireless transceiver 110 of the in-vehicle component 106 and the wireless transceiver 112 of the personal device 104, or from a time measurement of either arrival (TOA) or difference of arrival (TDOA).

One of the advantages of lateration using signal strength 116 is that it can leverage the already-existing received signal strength indication (RSSI) signal strength 116 information available in many communication protocols. For example, iBeacon uses the RSSI signal strength 116 information available in the Bluetooth Low-Energy (BLE) protocol to infer the distance of a beacon from a personal device 104 (i.e. a target), so that specific events can be triggered as the personal device 104 approaches the beacon. Other implementations expand on the concept, leveraging multiple references to estimate the location of the target. When the distance from three reference beacons are known, the location can be estimated in full (trilateration) from the following equations:

d₁²=(x−x₁)²+(y−y₁)²+(z−z₁)²

d₂²=(x−x₂)²+(y−y₂)²+(z−z₂)²

d₃²=(x−x₃)²+(y−y₃)²+(z−z₃)² (1)

In an example, as shown in FIG. 1C, an in-vehicle component 106-B may broadcast or otherwise send a request for signal strength 116 to other in-vehicle components 106-A and 106-C of the vehicle 102. This request may cause the other in-vehicle components 106-A and 106-C to return wireless signal strength 116 data identified by their respective wireless transceiver 110 for whatever devices they detect (e.g., signal strength 116-A for the personal device 104 identified by the wireless transceiver 110-A, signal strength 116-C for the personal device 104 identified by the wireless transceiver 110-C). Using these signal strengths 116-A and 116-C, as well as signal strength 116-B determined by the in-vehicle component 106-B using its wireless transceiver 110-B, the in-vehicle component 106-B may use the equations (1) to perform trilateration and locate the personal device 104. As another possibility, the in-vehicle component 106 may identify the personal device 104 with the highest signal strength 116 at the in-vehicle component 106 as being the personal device 104 within the zone 108 as follows:

$$Personal Device = i ⇒ {max}_{i - 1 , n} {RSSI}_{i} \qquad ( 2 )$$

In addition to determining in which zone 108 each personal device 104 is located (or which zone 108 is closest), the mesh of in-vehicle components 106 and the personal devices 104 may be utilized to allow the in-vehicle components 106 to identify whether the personal device 104 is located inside or outside of the vehicle, As one example, signal strengths 116 may be received from in-vehicle components 106, located in each of zones 108-A, 108-B, 108-C and 108-D. An average of the signal strengths 116 may be compared to a constant value k, such that if the average signal strength 116 exceeds the value k, then the personal device 104 is deemed to be within the vehicle 102, and if the average signal strength 116 does not exceed the value k, then the personal device 104 is deemed to be outside the vehicle 102.

Change in the signal strengths 116 may also be used to determine whether the personal device 104 is approaching the vehicle 102 or departing from the vehicle 102. As an example, if the average of the signal strengths 116 previously below an approach threshold signal level t becomes greater than the approach threshold signal level t, the personal device 104 may be detected as having approached the vehicle 102. Similarly, if the average of the signal strengths 116 previously above an approach threshold signal level t becomes less than the approach threshold signal level t, the personal device 104 may be detected as having departed from the vehicle 102.

Referring back to FIG. 1B, certain vehicle 102 functions may be secured functions requiring presence of the personal device 104 within the vehicle 102 for the function to be invoked. Providing of access codes 120 to personal devices 104 may be one such example. For instance, a user carrying the personal device 104 may authenticate with the vehicle 102 using an authentication mechanism such as a key, a key-fob, or entry of a passcode into a vehicle keypad. Once authenticated, the user may be granted access to the vehicle 102 and may settle into one of the seating positions or zones 108. When the personal device 104 of the user is recognized by signal strength 116 data from the in-vehicle components 106 as being inside the vehicle 102, a one-time-use access token 120 may be provided to the personal device 104 by an access component 122. The access token 120 may accordingly be saved to the user's personal device 104. When the user attempts to re-enter the vehicle 102 at a later time, the access token 120 may be provided to the vehicle 102 by the personal device 104 to re-authenticate the returning user.

The access token 120 may be an arbitrary data element. The access token 120 may be received from the vehicle 102 when the user enters the vehicle 102, and may be stored to a memory or other storage device of the personal device 104. The access token 120 may be retrieved from the storage and provided by the personal device 104 back to the vehicle 102 to facilitate re-entry of the user to the vehicle 102.

The access component 122 may include one or more devices of the vehicle 102 configured to facilitate access to the vehicle 102. In an example, the access component 122 may include a dedicated system configured to handle vehicle 102 access to vehicle 102 functions deemed to require security clearance, such as door unlocking or engine ignition. In another example, the access component 122 may be integrated into a module already present in the vehicle 102, such as a body controller of the vehicle 102 configured to handle door locking, security alarms, engine immobilizer control, keypad entry, or other vehicle 102 access and/or security functions. As another possibility, access component 122 may be implemented as an aspect of one of the in-vehicle components 106 (e.g., a light or other of the in-vehicle components 106 having sufficient processing capability) to reduce implementation complexity and cost.

It should be noted that the provisioning of access codes 120 to personal devices 104 is merely one example, and other examples of secured functions may be possible. Regardless of the function, the access component 122 may be configured to confirm or deny the personal device 104 with access based on whether or not the personal device 104 is located within the vehicle 102. For those functions, authorization to perform the function may be implicitly based on the user of the personal device 104 already have been given access to the interior of the vehicle 102.

The access component 122 may also be configured to maintain information indicative of which personal devices 104 are authorized to utilize security functions of the vehicle 102. In an example, the access component 122 may maintain an association of the device identifiers 124 of personal devices 104 in a component database 126 listing the authorized devices. As one possibility, the device identifiers 124 may be MAC addresses of the personal devices 104. The access component 122 may use the stored device identifiers 124 to confirm that the device identifiers 124 of the personal device 104 is authorized to utilize the vehicle 102 function that is requested by the personal device 104. If a personal device 104 attempts to use an access token 120 not associated with a device identifier 124, the access component 122 may raise or initiate an alert (e.g., sound an alarm, lock all vehicle 102 doors, contact a remote telematics service, etc.) The access component 122 may also maintain expired access codes 120, and may raise or initiate the alert when an expired access token 120 is presented to the vehicle 102.

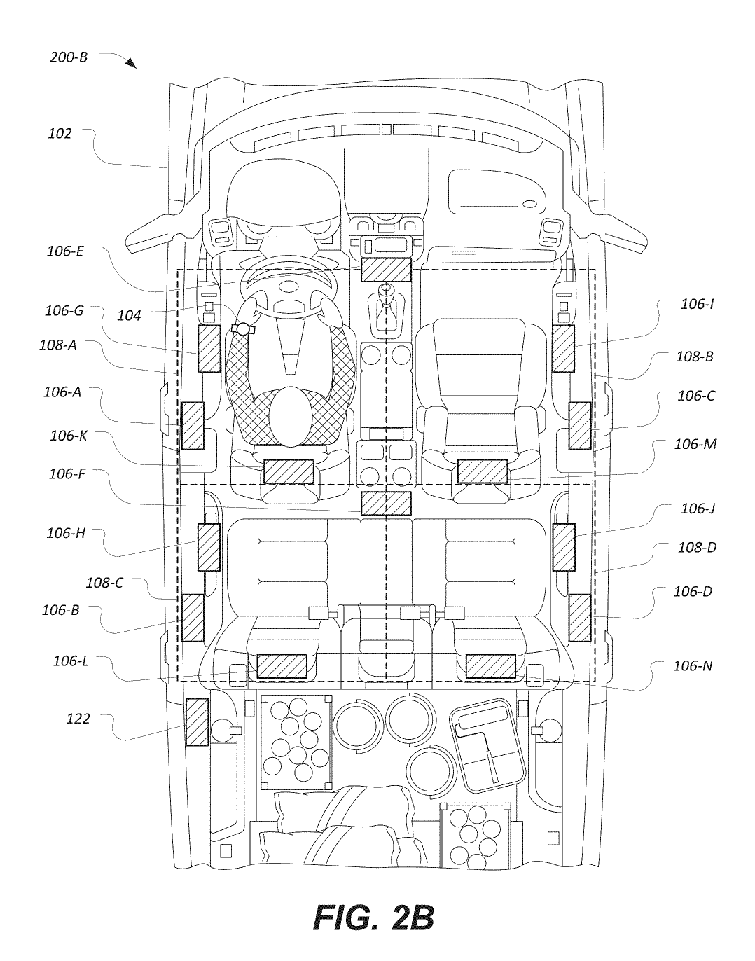

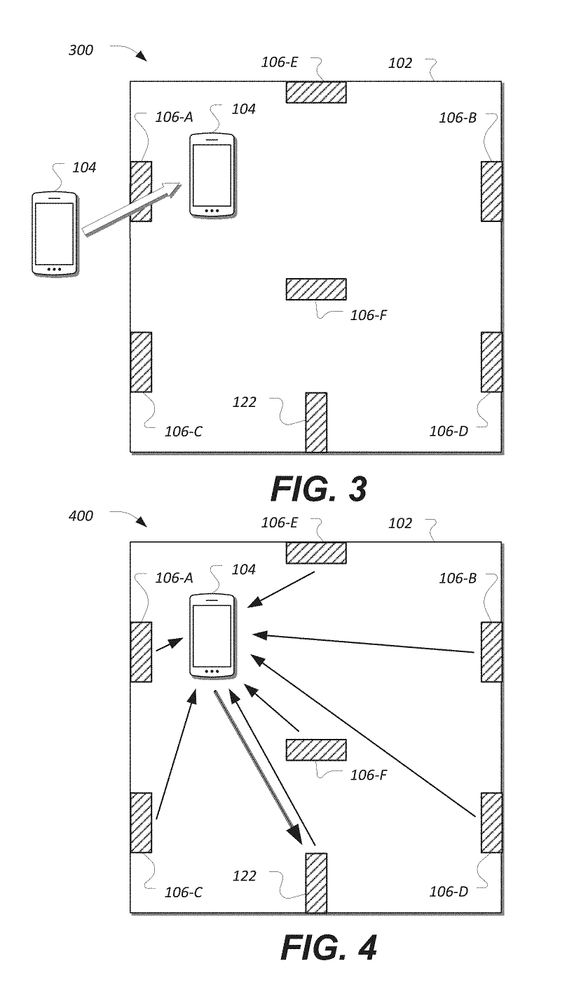

FIG. 2A illustrates an example diagram 200-A of a user carrying a personal device 104 lacking an access token 120 attempting entry to the vehicle 102. In an example, the personal device 104 may have never before been encountered by the mesh of in-vehicle components 106. In another example, the personal device 104 may have been previously encountered by the mesh of in-vehicle components 106, but may no longer be authorized to the vehicle 102 (e.g., no access token 120). Situations in which the personal device 104 is detected but does not have an access token 120 with access rights to the vehicle 102 may be referred to as a first-time access.

In order for the user of the personal device 104 to be granted first-time access to the vehicle 102, the user may be required to authenticate with the vehicle 102 using an authentication mechanism other than use of the access token 120. As some examples, the user may utilize a key, a key-fob, entry of a passcode into a vehicle keypad, or some other type of access method to gain entry to the vehicle 102. In many cases, these authentications may be performed by way of the access component 122. In other cases, the authentications may be performed by another module, such as by the body controller, and the access component 122 may be notified of the authentication. Regardless of approach, the user may accordingly be granted access to the vehicle 102, and may enter the vehicle 102 to one of the zones 108.

FIG. 2B illustrates an example diagram 200-B of the user carrying the personal device 104 having entered the vehicle 102. As the personal device 104 is recognized to be inside the vehicle 102, an access token 120 may be generated by the access component 122, and sent from the access component 122 to the personal device 104. The personal device 104 may receive the access token 120 granting the user of the personal device 104 access rights to re-enter the vehicle 102 at a later time. The access component 122 may maintain the access token 120 in association with a device identifier 124 of the personal device 104. This may allow the access component 122 to confirm that the access token 120 provided by the returning personal device 104 is valid for the personal device 104.

The access token 120 may be sent to the personal device 104 through various approaches. In an example, the access token 120 may be sent by the access component 122 to the personal device 104 using the wireless transceiver 110 of the access component 122. As another example, the access token 120 may be sent by the access component 122 to another of the in-vehicle components 106 (e.g., an in-vehicle component 106 within the zone 108 of the personal device 104), and that in-vehicle components 106 may in turn forward the access token 120 to the personal device 104. As another possibility, the access token 120 may be sent to the personal device 104 when the vehicle 102 is in motion. For instance, the access component 122 may confirm that the vehicle 102 has been in motion for a predetermined number of seconds before sending the access token 120 (e.g., based on vehicle 102 data received by the access component 122 from the vehicle bus). Because the wireless signal transmitting the access token 120 is short range, and is sent from inside an enclosed and moving vehicle 102, it may be difficult for a third party to intercept the access token 120 transmission.

The access token 120 may provide access rights that that are set based on the zone 108 of the user. As an example, if the user is located within the driver zone 108-A or, as another possibility, within the front row of the vehicle 102, the access token 120 may provide the user with access rights to re-enter the front row and other rows of the vehicle 102. As another example, if the user is located within the second row (e.g., zones 108-C or 108-D), the access token 120 may provide the user with access rights to re-enter the second row but not the front row. Additionally or alternately, the access rights of the access token 120 may be set according to settings of the vehicle 102. For instance, the access rights settings may be configured by a user operating the vehicle component interface application 118 on the personal device 104 of a device identified by the access component 122 as the owner device.

Thus, the re-entrance to the vehicle 102 of the user carrying the personal device 104 is based on the previous authenticated presence of the personal device 104 as being inside the vehicle 102. Which devices perform the triangulation, and where it is performed, therefore may be relevant to robustness of securing the access token 120 procedure.

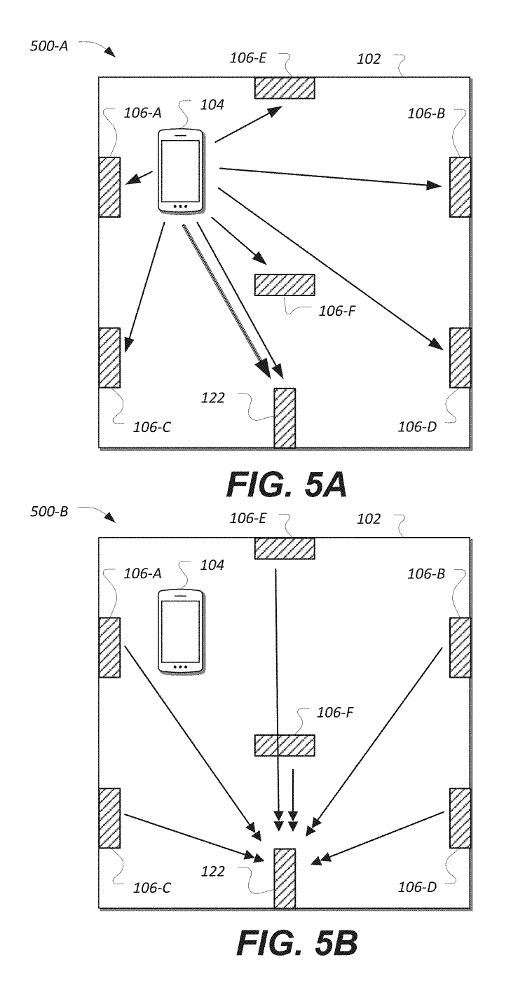

FIG. 3 illustrates an example diagram 300 of the personal device 104 entering the vehicle 102. In an example, the personal device 104 may be carried into the vehicle 102 by a user. As shown, the vehicle 102 includes in-vehicle components 106-A through 106-F and the access component 122 (also an in-vehicle component 106) arranged with respect to the vehicle 102 cabin.

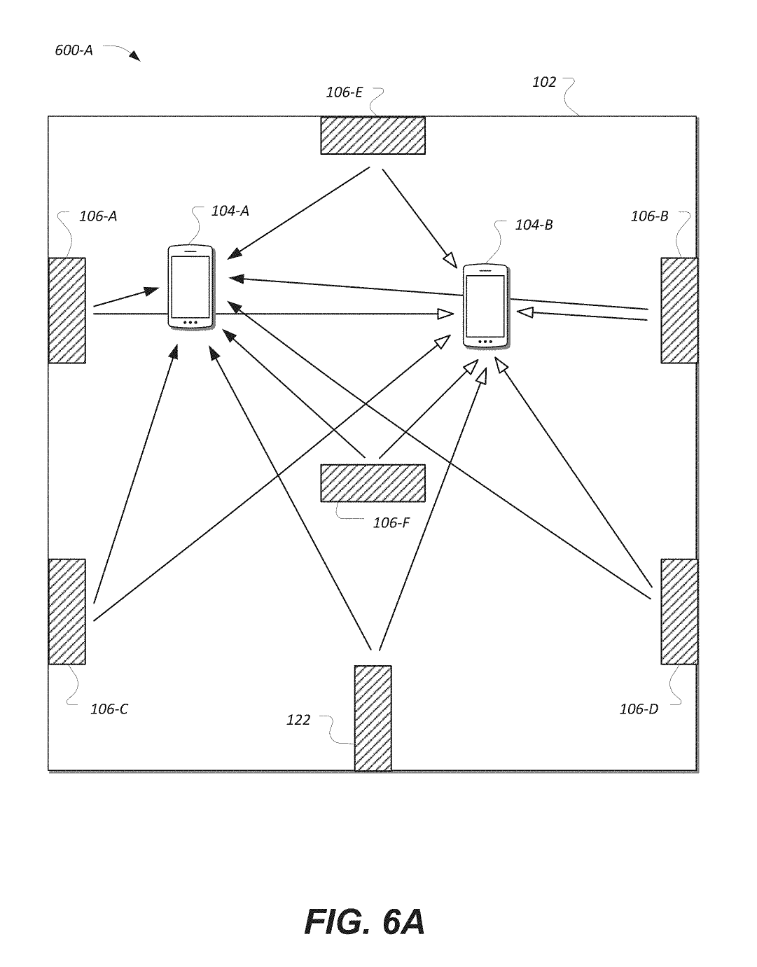

FIG. 4 illustrates an example diagram 400 of a personal device-centric approach to identifying the location of the personal device 104. As shown, the personal device 104 determines the location of the personal device 104 according to signal strength 116 information between the in-vehicle components 106 and the personal device 104. This location may include in which seating zone 108 of the vehicle the personal device 104-A is located, or whether the personal device 104-A is located inside or outside the vehicle 102. As shown, the personal device 104 is located in the driver seating zone 108.

To perform the location identification, each in-vehicle components 106 may advertise or otherwise broadcast its respective location within the vehicle 102. In an example, the respective locations may be provided as Cartesian coordinates relative to the vehicle 102 cabin. Additionally, each in-vehicle component 106 may provide signal strength 116 information related to the signal strength observed between the personal device 104 and the respective in-vehicle component 106. This signal strength 116 information being received by the personal device 104 is represented in the diagram 400 as the small arrows from each of the in-vehicle components 106-A through 106-F and the access component 122 to the personal device 104.

The personal device 104 may receive the signal strength 116 information, and perform trilateration to determine the location of the personal device 104. For instance, the signal strength 116 information may be used to allow the personal device 104 to determine whether the device is located inside or outside the vehicle 102.

If the personal device 104 determines that its location is within the vehicle 102, the personal device 104 may send a secured function request to the access component 122. The secured function request is represented in the diagram 400 as the large arrow from the personal device 104 to the access component 122. To continue with the access token 120 example, the secured function request may be a request from the personal device 104 for an access token 120 for future use by the personal device 104 for regaining entry to the vehicle 102. The personal device-centric approach may be simple to implement, but relies on the personal device 104 to honestly declare whether it is located inside or outside the vehicle 102.

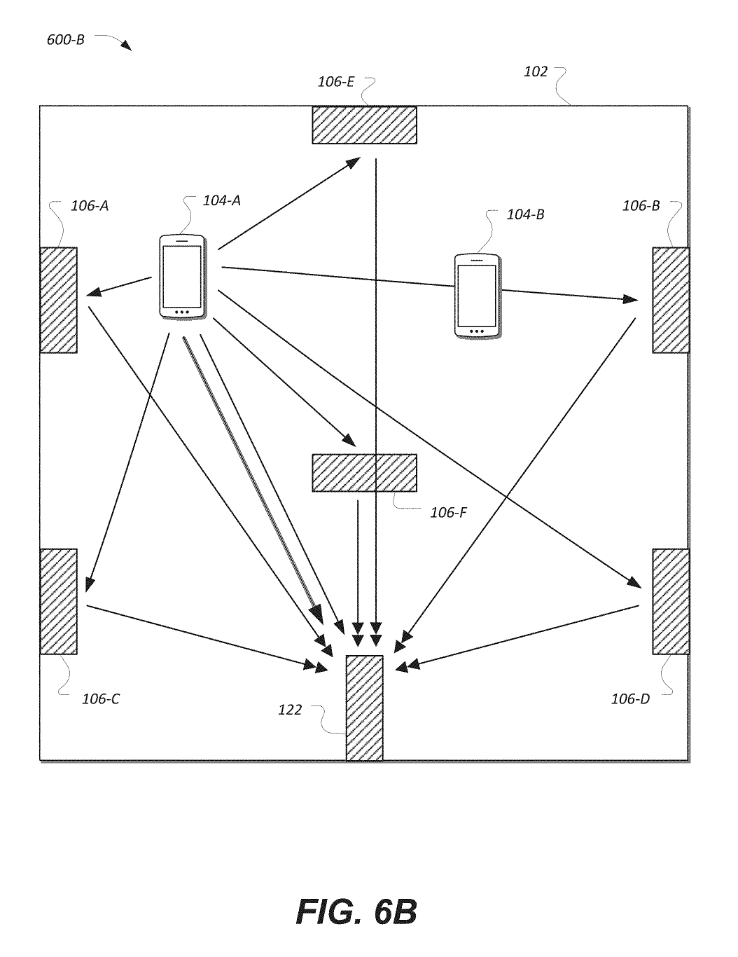

FIGS. 5A and 5B illustrate example diagrams 500 of an access component-centric approach to identifying the location of the personal device 104. In the access component-centric approach, the vehicle 102 components performing secured functions (e.g., the access component 122) are configured to perform the location determination of the personal device 104.

As shown in the example diagram 500-A of FIG. 5A, the personal device 104 may be advertising itself (e.g., via BLE), thus enabling the in-vehicle components 106 to determine the intensity of the signal strength 116 information between the personal device 104 and the in-vehicle components 106 as it is received. The signal strength 116 information being received by the in-vehicle components 106-A through 106-F and the access component 122 is represented in the diagram 500-A as the small arrows from the personal device 104 to each of the in-vehicle components 106-A through 106-F and the access component 122. The personal device 104 also sends the secured function request to the access component 122 requesting a function of the access component 122. The secured function request is represented in the diagram 500-A as the large arrow from the personal device 104 to the access component 122.

As shown in the example diagram 500-B of FIG. 5B, each of the in-vehicle components 106 forwards the address (e.g., MAC address) of the personal device 104 and its respective signal strength 116 information in an advertisement packet that is received by the access component 122. The signal strength 116 information being forwarded from the in-vehicle components 106 to the access component 122 is represented in the diagram 500-B as the double-headed arrows from each of the in-vehicle components 106-A through 106-F to the access component 122. The access component 122 may receive the signal strength 116 information, and may use the information to perform triangulation for the personal device 104. If the access component 122 determines that the personal device 104 is located within the vehicle 102, the access component 122 may validate the secured function request.

As compared to the personal device-centric approach, the access component-centric approach is more robust to hacking, as it may be difficult to spoof the signal strength 116 information to all of the in-vehicle components 106 congruently and simultaneously. However, the advertising and forwarding of signal strength 116 information from the in-vehicle components 106 and reception and analysis of such information by the access component 122 may be more resource-intensive than triangulation performed by the personal device 104, and therefore may not scale as the number of personal devices 104 increases. For instance, in the access component-centric approach each personal device 104 is triangulated regardless of whether the personal device 104 is located inside or outside the vehicle 102, and regardless of whether the personal device 104 is requesting an interaction with a secured function of the vehicle 102 interior.

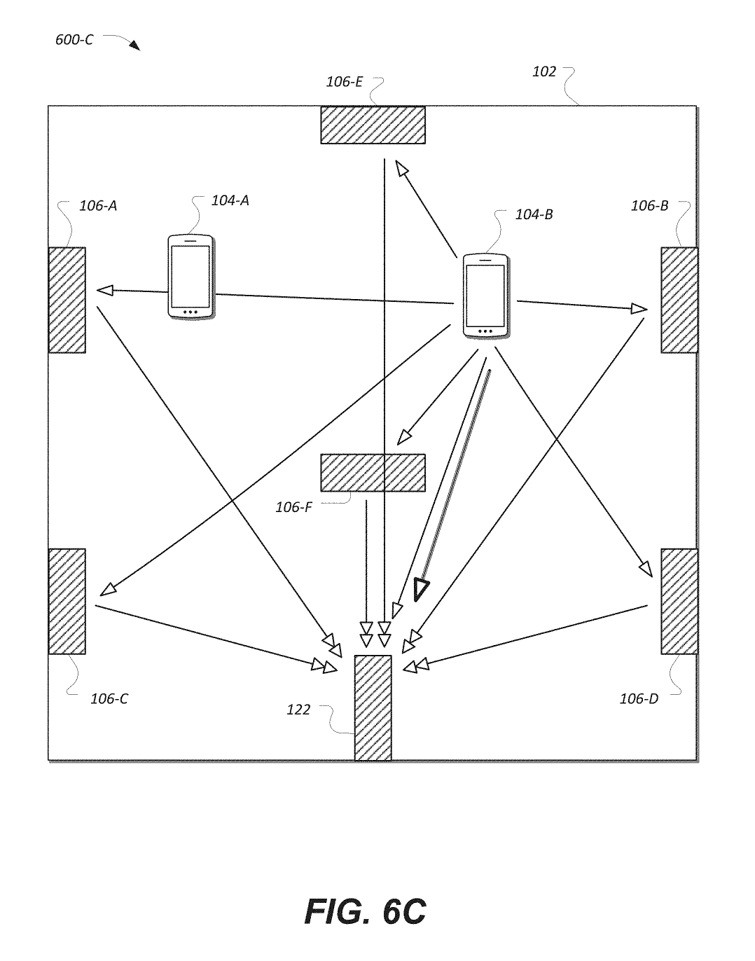

FIGS. 6A, 6B and 6C illustrate example diagrams 600 of a hybrid approach to identifying the location of a plurality of personal devices 104. The hybrid approach may utilize a first triangulation performed on the personal device 104 requesting a secured function, and a second triangulation performed by the access component 122 confirming the personal device 104 location.

As shown in the example diagram 600-A, a first personal device 104-A may receive signal strength 116 information each of the in-vehicle components 106 of the vehicle 102 to the first personal device 104-A. This signal strength 116 information being received by the personal device 104-A is represented in the diagram 600-A as the small black arrows from each of the in-vehicle components 106-A through 106-F and the access component 122 to the personal device 104-A. Additionally a second personal device 104-B may receive signal strength 116 information of each of the in-vehicle components 106 of the vehicle 102 to the second personal device 104-B. This signal strength 116 information being received by the personal device 104-B is represented in the diagram 600-A as the small white arrows from each of the in-vehicle components 106-A through 106-F and the access component 122 to the personal device 104-B. Additionally, each of the in-vehicle components 106 may advertise or otherwise broadcast its respective location within the vehicle 102.

The personal device 104-A may receive its signal strength 116 information, and may perform trilateration to determine the location of the personal device 104-A. The personal device 104-B may also receive its corresponding signal strength 116 information, and may perform trilateration to determine the location of the personal device 104-B.

Referring to the example diagram 600-B of FIG. 6B, the personal device 104-A determines that it is located inside the interior of the vehicle 102, and sends a request for validation to the SMC module providing the critical function (e.g., the access component 122). The secured function request is represented in the diagram 600-B as the large black arrow from the personal device 104-A to the access component 122.

Also as shown in the example diagram 600-B, each of the in-vehicle components 106 forwards the address (e.g., MAC address) of the personal device 104-A and its respective signal strength 116 information in an advertisement packet to be read by the access component 122. The signal strength 116 information being forwarded from the in-vehicle components 106 to the access component 122 is represented in the diagram 600-B as the double-headed black arrows from each of the in-vehicle components 106-A through 106-F to the access component 122. The access component 122 may receive the signal strength 116 information, and may use the information to perform a second triangulation for the personal device 104-A.

If the access component 122 confirms by the second triangulation that the personal device 104-A is located within the vehicle 102, the access component 122 may validate the secured function request from the personal device 104-A. The location of the personal device 104-A as being within the vehicle 102 may also be updated in a component database 126 of the access component 122 indicating which personal devices 104 are confirmed to be inside the vehicle 102, and may be used for authentication of further the secured function requests without additional triangulations performed by the access component 122.

Referring to the example diagram 600-C of FIG. 6C, when the personal device 104-B determines that it is located inside the interior of the vehicle 102, the personal device 104-B similarly sends a request for validation to the SMC module providing the critical function (e.g., the access component 122). The secured function request is represented in the diagram 600-C as the large white arrow from the personal device 104-A to the access component 122.

Also as shown in the example diagram 600-C, each of the in-vehicle components 106 forwards the address (e.g., MAC address) of the personal device 104-B and its respective signal strength 116 information in an advertisement packet to be read by the access component 122. The signal strength 116 information being forwarded from the in-vehicle components 106 to the access component 122 is represented in the diagram 600-C as the double-headed white arrows from each of the in-vehicle components 106-A through 106-F to the access component 122. The access component 122 may receive the signal strength 116 information, and may use the information to perform a second triangulation for the personal device 104-B.

If the access component 122 confirms by the second triangulation that the personal device 104-B is located within the vehicle 102, the access component 122 may validate the secured function request from the personal device 104-B. The location of the personal device 104-B as being within the vehicle 102 may also be updated in a component database 126 of the access component 122 indicating which personal devices 104 are confirmed to be inside the vehicle 102, and may be used for authentication of further the secured function requests without additional triangulations performed by the access component 122.

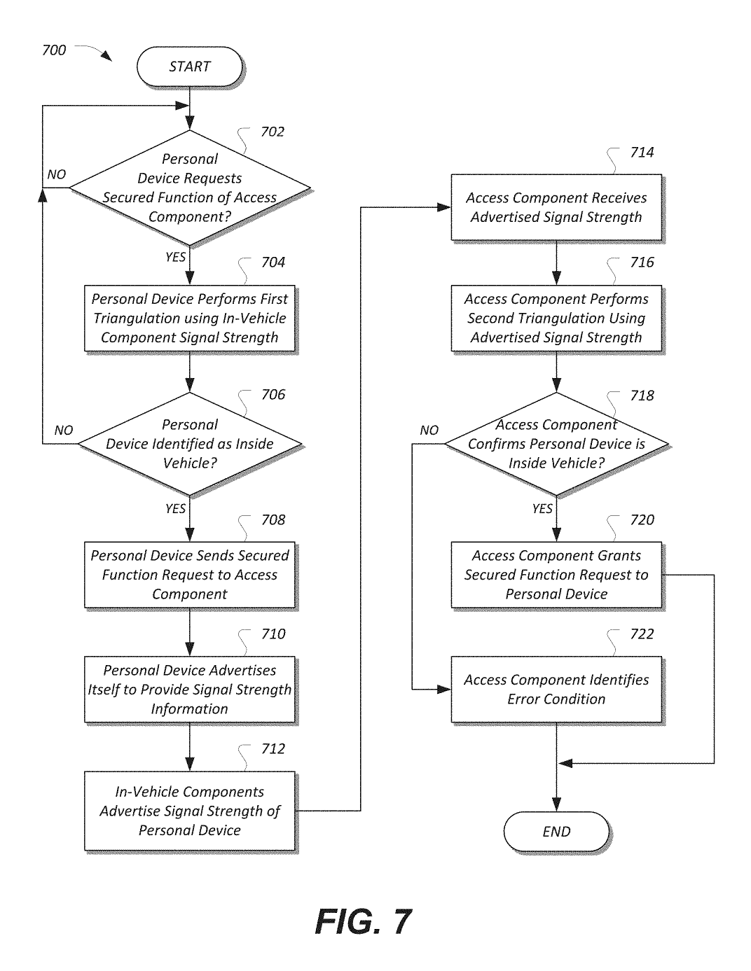

FIG. 7 illustrates an example process 700 for using the hybrid approach to identify locations of personal devices 104. The process 700 may be performed, in an example, by the access component 122 and personal device 104 in communication with the in-vehicle components 106.

At operation 702, the personal device 104 determines whether a secured function of the access component 122 is being requested. In an example, a user of the personal device 104 may indicate a request for an access token 120 from the access component 122, where the access token 120 may be later provided to the vehicle 102 by the personal device 104 to regain access to the vehicle 102.

At 704, the personal device 104 performs a first triangulation using the in-vehicle component 106 signal strength 116 information. In an example, each in-vehicle component 106 may provide signal strength 116 information related to the signal strength observed between the personal device 104 and the respective in-vehicle component 106. The personal device 104 may receive the signal strength 116 information, and perform trilateration to determine the location of the personal device 104.

At operation 706, the personal device 104 determines whether the personal device 104 is inside the vehicle 102. As one example, an average of the signal strengths 116 may be compared to a constant value k, such that if the average signal strength 116 exceeds the value k, then the personal device 104 is deemed to be within the vehicle 102, and if the average signal strength 116 does not exceed the value k, then the personal device 104 is deemed to be outside the vehicle 102. If the personal device 104 determines it is within the vehicle 102, control passes to operation 708. Otherwise, control retunes to operation 702 (or in other examples the process 700 ends, not shown).

At 708, the personal device 104 sends the secured function request to the access component 122. Thus, when the personal device 104 determines it is authorized to perform the secured action, the personal device 104 sends the secured function request to the access component 122.

At 710, the personal device 104 advertises itself to allow the in-vehicle components 106 to collect signal strength 116 information. In an example, the personal device 104 advertises via BLE, enabling the in-vehicle components 106 to determine the intensity of the signal strength 116 information between the personal device 104 and the in-vehicle components 106 as it is received.

At operation 712, the in-vehicle components 106 advertise the signal strength 116 of the personal device 104 to the access component 122. In an example, each of the in-vehicle components 106 forwards the address (e.g., MAC address) of the personal device 104 and its respective signal strength 116 information in BLE advertisements that may be received by the access component 122.

At 714, the access component 122 receives the advertised signal strength 116 information. In an example, the access component 122 receives the BLE advertisements of the signal strength 116 to the personal devices 104 from the in-vehicle components 106.

At operation 716, the access component 122 performs a second triangulation using the advertised signal strength 116 information. Thus, the access component 122 use the received signal strength 116 information to independently identify the location of the personal device 104.

At operation 718, the access component 122 confirms whether the personal device 104 is located within the vehicle 102. In an example, if the access component 122 determines using the second triangulation that the personal device 104 is within the vehicle 102, control passes to operation 720. If not, control passes to operation 722.

At 720, the access component 122 grants the secured function request to the personal device 104. Thus, the access component 122 may validate the secured function request from the personal device 104. In an example, responsive to the granting of a request for an access token 120, the access component 122 may send the access token 120 to the personal device 104 when the vehicle 102 is determined to have been in motion for a predetermined amount of time (e.g., five seconds, one minute, etc.). Because the wireless signal transmitting the access token 120 is short range, and is sent from inside an enclosed and moving vehicle 102, it may be difficult for a third party to intercept the access token 120 transmission. Additionally, the location of the personal device 104 as being within the vehicle 102 may also be updated in the component database 126 of the access component 122 indicating which personal devices 104 are confirmed to be inside the vehicle 102, and may be used for authentication of further the secured function requests without additional triangulations performed by the access component 122. After operation 720, the process 700 ends.

At operation 722, the access component 122 identifies an error condition with respect to the secured function request. As some examples, the access component 122 may raise or initiate an alert (e.g., sound an alarm, lock all vehicle 102 doors, contact a remote telematics service, etc.) if the personal device 104 is not confirmed to be within the vehicle 102. After operation 722, the process 700 ends.

Computing devices described herein, such as the personal devices 104, in-vehicle components 106, and access components 122, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
vehicle interior components each with wireless communication interfaces; and
an access component of a vehicle, programmed to
triangulate a personal device self-identifying as within the vehicle, responsive to a secured function request from the personal device, to identify a location of the personal device using wireless signal strength information of the personal device wirelessly advertised by the components, and
grant the secured function request when the location is confirmed inside the vehicle.

2. The system of claim 1, wherein the access component is further programmed to initiate an alert when the location is not inside the vehicle.

3. The system of claim 1, wherein the access component is further programmed to, when the location is inside the vehicle, add an address of the personal device to a component database of authorized devices.

4. The system of claim 3, wherein the access component is further programmed to:
receive a second secured function request from the personal device; and
grant the second secured function request without performing a triangulation to identify the location when the component database of authorized devices lists the personal device as being inside the vehicle.

5. The system of claim 1, wherein the signal strength information of the personal device forwarded to the access component includes a media access control address of the personal device.

6. The system of claim 1, wherein the secured function request is received from the personal device responsive to the personal device identifying the location of the personal device as being within the vehicle.

7. The system of claim 1, wherein the in-vehicle components include Bluetooth low energy (BLE) transceivers, and the signal strength information includes BLE Received Signal Strength Indicator (RSSI) information.

8. The system of claim 1, wherein the secured function request is for an access token to be used by the personal device as authorization to re-enter the vehicle.

9. A method comprising:
receiving, by an access component, a secured function request from a personal device when a first triangulation performed by the personal device indicates the personal device is within a vehicle; and
granting the secured function request when a second triangulation performed by the access component using signal strength information of the personal device forwarded to the access component as wireless advertisements from a plurality of in-vehicle components confirms the personal device is within the vehicle.

10. The method of claim 9, further comprising initiating an alert when the second triangulation fails to confirm that the personal device is within the vehicle.

11. The method of claim 9, further comprising, when the personal device is inside the vehicle, adding an address of the personal device to a component database of authorized devices.

12. The method of claim 11, further comprising:
receiving a second secured function request from the personal device; and
granting the second secured function request without performing a triangulation when the component database of authorized devices lists the personal device as being inside the vehicle.

13. The method of claim 9, further comprising:
receiving a second secured function request from a second personal device; and
granting the second secured function request without performing a triangulation when a component database of authorized devices lists the second personal device as being inside the vehicle, and otherwise performing a third triangulation by the access component using signal strength information of the second personal device forwarded to the access component from a plurality of in-vehicle components to confirm the second personal device as being within the vehicle.

14. The method of claim 9, wherein the signal strength information of the personal device includes a media access control address of the personal device.

15. The method of claim 9, wherein the secured function request is for an access token to be used by the personal device as authorization to re-enter the vehicle.

16. A system comprising:
a personal device including a wireless transceiver and a processor programmed to
send a secured function request to an access component of a vehicle when a location of the personal device is determined to be within the vehicle according to a first triangulation performed using signal strength information of connections between the wireless transceiver and a plurality of in-vehicle components of the vehicle; and
receive a response granting the secured function request from the access component when signal strength information of the personal device forwarded to the access component as wireless advertisements from the plurality of in-vehicle components confirms the location of the personal device as being within the vehicle.

17. The system of claim 16, wherein the processor is further programmed to advertise the personal device to the plurality of in-vehicle components to allow the plurality of in-vehicle components to determine the signal strength information of the personal device to be forwarded to the access component.

18. The system of claim 16, wherein the secured function request is for an access token to be used by the personal device as authorization to re-enter the vehicle.
